(19) United States
(12) Patent Application Publication
(10) Pub. No.: US 2018/0109125 A1
(43) Pub. Date: Apr. 19, 2018

(54) Smart Phone Charging System

(71) Applicant: Aaron Everest, Roy, UT (US)

(72) Inventor: Aaron Everest, Roy, UT (US)

(21) Appl. No.: 15/293,831

(22) Filed: Oct. 14, 2016

(51) Int. Cl. H02J 7/00; H02J 7/34; H04B 1/3883

(52) U.S. Cl. CPC H02J 7/0052; H02J 7/0045; H04B 1/3883; H02J 7/34; H02J 7/0044

(57) ABSTRACT

A smart phone charging system includes a bicycle that has a frame, handlebars and a rear tire. An electronic device is provided. A charging unit is coupled to the frame. The charging unit engages the rear tire such that the rear tire rotates the charging unit. Thus, the charging unit produces an electrical current. The charging unit is electrically coupled to the electronic device such that the charging unit charges the electronic device. A gripping unit is coupled to the handlebars. The gripping unit engages the electronic device such that the electronic device is accessible to a rider.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

[symbol]

### (2) Description of Related Art Including Information Disclosed Under 37 CFR 1.97 and 1.98

The disclosure and prior art relates to charging devices and more particularly pertains to a new charging device for charging an electronic device on a bicycle.

### BRIEF SUMMARY OF THE INVENTION

An embodiment of the disclosure meets the needs presented above by generally comprising a bicycle that has a frame, handlebars and a rear tire. An electronic device is provided. A charging unit is coupled to the frame. The charging unit engages the rear tire such that the rear tire rotates the charging unit. Thus, the charging unit produces an electrical current. The charging unit is electrically coupled to the electronic device such that the charging unit charges the electronic device. A gripping unit is coupled to the handlebars. The gripping unit engages the electronic device such that the electronic device is accessible to a rider.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a smart phone charging system according to an embodiment of the disclosure.

FIG. 2 is a front view of gripping unit of an embodiment of the disclosure.

FIG. 3 is a right side view of gripping unit of an embodiment of the disclosure.

FIG. 4 is a top perspective view of an embodiment of the disclosure.

FIG. 5 is a perspective in-use view of an embodiment of the disclosure.

### DETAILED DESCRIPTION OF THE INVENTION

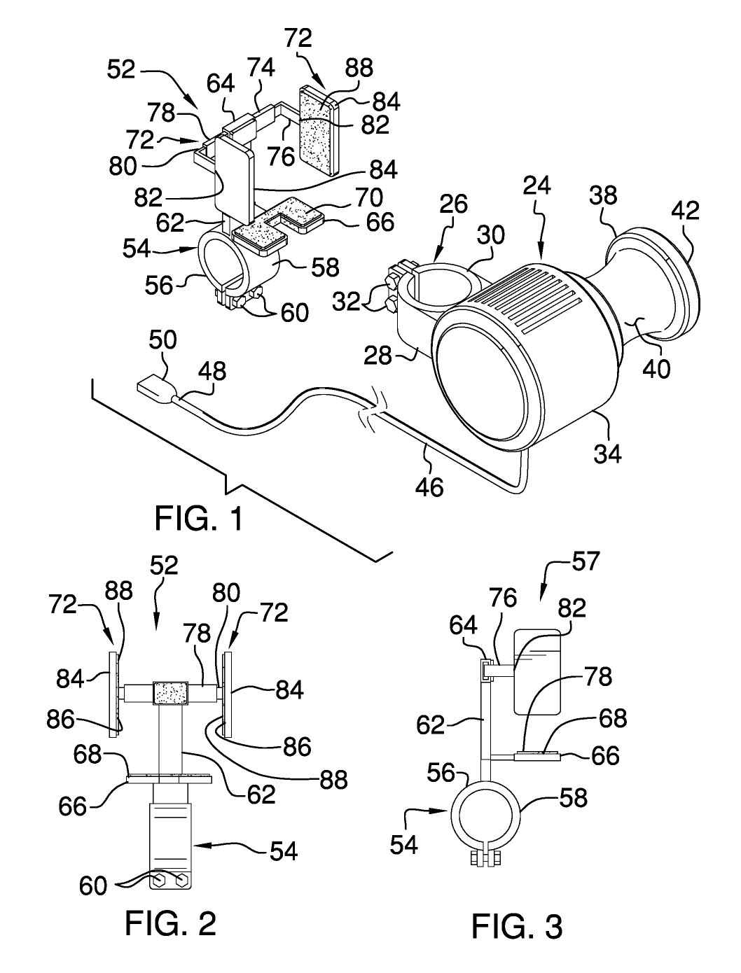

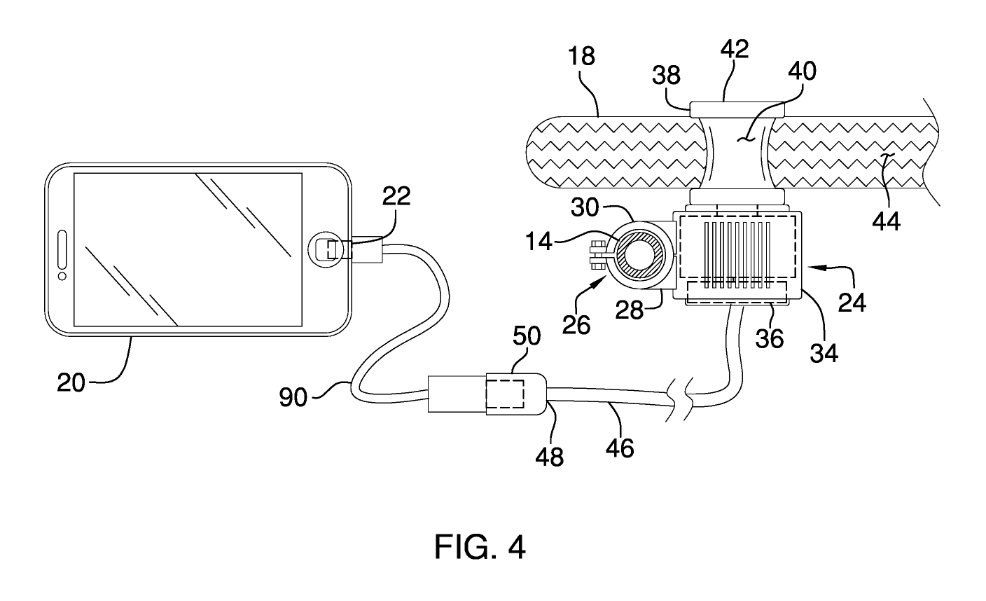

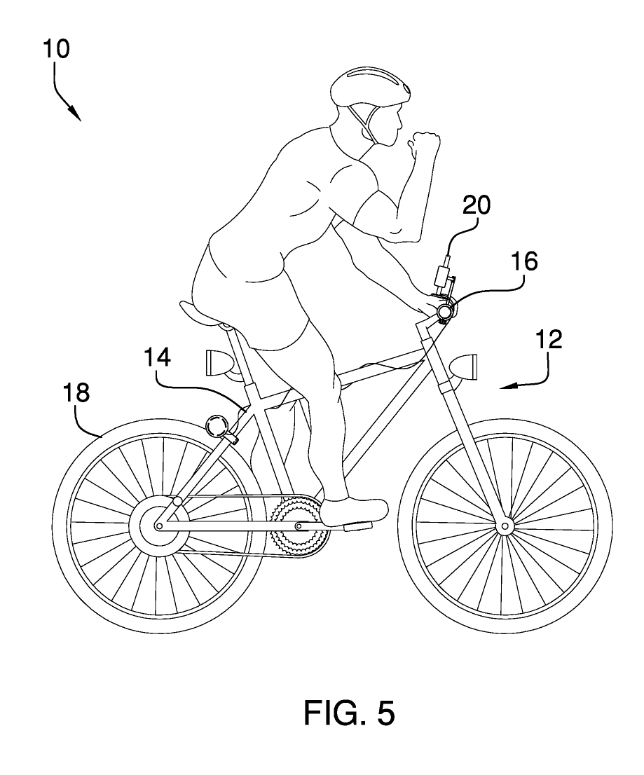

With reference now to the drawings, and in particular to FIGS. 1 through 5 thereof, a new charging device embodying the principles and concepts of an embodiment of the disclosure and generally designated by the reference numeral 10 will be described.

As best illustrated in FIGS. 1 through 5, the smart phone charging system 10 generally comprises a bicycle 12 that has a frame 14, handlebars 16 and a rear tire 18. The bicycle 12 may be a bicycle 12 of any conventional design. An electronic device 20 is provided. The electronic device 20 has a charge port 22. The electronic device 20 may comprise a smart phone or the like.

A charging unit 24 is provided and the charging unit 24 is coupled to the frame 14 of the bicycle 12. The charging unit 24 engages the rear tire 18. The rear tire 18 rotates the charging unit 24 such that the charging unit 24 produces an electrical current. The charging unit 24 is electrically coupled to the electronic device 20. Thus, the charging unit 24 charges the electronic device 20.

The charging unit 24 comprises a first clamp 26. The first clamp 26 is continuous such that the first clamp 26 forms an open ring. The first clamp 26 has a first side 28 and a second side 30. The first clamp 26 is positioned around the frame 14. The first clamp 26 is positioned adjacent to the rear tire 18.

A pair of first fasteners 32 is provided. Each of the first fasteners 32 extends through the first side 28 and engages the second side 30. Each of the first fasteners 32 may be manipulated. Each of the first fasteners 32 urges the first side 28 toward the second side 30. Thus, the first clamp 26 is compressed around the frame 14 thereby retaining the first clamp 26 on the frame 14.

A generator 34 is provided. The generator 34 is coupled to the first clamp 26. The generator 34 may comprise a DC generator 34 or the like. A battery 36 is positioned within the generator 34. The battery 36 is electrically coupled to the generator 34 such that the generator 34 charges the battery 36. The battery 36 may include a voltage regulator or the like.

A spindle 38 is rotatably coupled to the generator 34. The spindle 38 has an outer surface 40 and a distal end 42 with respect to the generator 34. The outer surface 40 is concavely arcuate between the generator 34 and the distal end 42. The outer surface 40 frictionally engages an outer surface 44 of the rear tire 18. The rear tire 18 rotates the spindle 38 when the bicycle 12 is ridden. Thus, the spindle 38 rotates the generator 34.

A first conductor 46 is provided. The first conductor 46 is electrically coupled to the battery 36. The first conductor 46 has a distal end 48 with respect to the battery 36. A plug 50 is electrically coupled to the distal end 48 of the first conductor 46. The first conductor 46 may be a usb cable or the like.

A gripping unit 52 is provided. The gripping unit 52 is coupled to the handlebars 16. The gripping unit 52 engages the electronic device 20. Thus, the electronic device 20 is accessible to a rider.

The gripping unit 52 comprises a second clamp 54. The second clamp 54 is continuous such that the second clamp 54 forms an open ring. The second clamp 54 has a primary side 56 and a secondary side 58. The second clamp 54 is positioned around the handlebars 16.

A pair of second fasteners 60 is provided. Each of the second fasteners 60 extends through the primary side 56 and engages the secondary side 58. Each of the second fasteners 60 may be manipulated. Each of the second fasteners 60 urges the primary side 56 toward the secondary side 58. Thus, the second clamp 54 is compressed around the handlebars 16 to retain the second clamp 54 on the handlebars 16.

A stand 62 is provided. The stand 62 is coupled to and extends away from the second clamp 54. The stand 62 has a distal end 64 with respect to the second clamp 54. The stand 62 is oriented to extend upwardly from the handlebars 16.

A base 66 is coupled to and extends away from the stand 62. The base 66 is positioned closer to the second clamp 54 than the distal end 64 of the stand 62. The base 66 has a first surface 68. The first surface 68 faces the distal end 64 of the stand 62. A first pad 70 is coupled to the first surface 68. The first pad 70 may be comprised of a resiliently compressible material.

A pair of grips 72 is provided. Each of the grips 72 is coupled to the stand 62. Each of the grips 72 is aligned with the distal end 42 of the stand 62. Moreover, each of the grips 72 is positioned on opposite sides of the stand 62.

Each of the grips 72 comprises a leg 74 and a foot 76. The leg 74 corresponding to each of the grips 72 extends laterally away from the stand 62. The foot 76 corresponding to each of the grips 72 extends perpendicularly away from the stand 62. The leg 74 corresponding to each of the grips 72 has a first section 78 that is slidably coupled to a second section 80. Thus, the leg 74 corresponding to each of the grips 72 has a telescopically adjustable length. The foot 76 corresponding to each of the grips 72 has a first end 82.

A pair of panels 84 is provided. Each of the panels 84 is coupled to the first end 82 of an associated one of the grips 72. Each of the panels 84 has a primary surface 86. The primary surface 86 of each of the panels 84 faces each other. A pair of second pads 88 may be provided. Each of the second pads 88 may be coupled to the primary surface 86 of an associated one of the panels 84. Each of the second pads 88 may be comprised of a resiliently compressible material.

The electronic device 20 is positioned on the first surface 68 of the base 66. Each of the panels 84 is urged toward each other. The primary surface 86 of each of the panels 84 frictionally engages the electronic device 20. Thus, the electronic device 20 is retained in the gripping unit 52.

A second conductor 90 is provided. The second conductor 90 is selectively electrically coupled between the plug 50 on the first conductor 46 and the charge port 22 on the electronic device 20. Thus, the battery 36 charges the electronic device 20. The second conductor 90 may be a usb cord or the like.

In use, the first clamp 26 is coupled to the frame 14 of the bicycle 12 such that the spindle 38 engages the rear tire 18. The second clamp 54 is coupled to the handlebars 16. The electronic device 20 is positioned in the gripping unit 52. The second conductor 90 is electrically coupled between the first conductor 46 and the electronic device 20. Thus, the generator 34 charges the electronic device 20 when the bicycle 12 is ridden.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A smart phone charging system comprising:
a bicycle having a frame, handlebars and a rear tire;
an electronic device;
a charging unit being coupled to said frame, said charging unit engaging said rear tire such that said rear tire rotates said charging unit wherein said charging unit is configured to produce an electrical current, said charging unit being electrically coupled to said electronic device such that said charging unit charges said electronic device, said charging unit including a first clamp being continuous such that said first clamp forms an open ring, said first clamp having a first side and a second side, said first clamp being positioned around said frame, said first clamp being positioned adjacent to said rear tire;
a gripping unit being coupled to said handlebars, said gripping unit engaging said electronic device wherein said electronic device is configured to be accessible to a rider;
a generator being coupled to said first clamp;
a battery being positioned within said generator, said battery being electrically coupled to said generator such that said generator charges said battery; and
a spindle being rotatably coupled to said generator, said spindle having an outer surface and a distal end with respect to said generator, said outer surface being concavely arcuate extending from said distal end towards said generator, said outer surface frictionally engaging a convex outer surface of said rear tire, said rear tire rotating said spindle when said bicycle is ridden such that said spindle rotates said generator.

2. (canceled)

3. The system according to claim 1, further comprising a pair of first fasteners, each of said first fasteners extending through said first side and engaging said second side wherein each of said first fasteners is configured to be manipulated, each of said first fasteners urging said first side toward said second side such that said first clamp is compressed around said frame thereby retaining said first clamp on said frame.

4. (canceled)

5. (canceled)

6. The system according to claim 1, further comprising a first conductor being electrically coupled to said battery, said first conductor having a distal end with respect to said battery, said distal end of said first conductor having a plug being electrically coupled thereto.

7. The system according to claim 1, wherein said gripping unit comprises a second clamp being continuous such that said second clamp forms an open ring, said second clamp having a primary side and a secondary side, said second clamp being positioned around said handlebars.

8. The system according to claim 7, further comprising a pair of second fasteners, each of said second fasteners extending through said primary side and engaging said secondary side wherein each of said second fasteners is configured to be manipulated, each of said second fasteners urging said primary side toward said secondary side such that said second clamp is compressed around said handlebars thereby retaining said second clamp on said handlebars.

9. The system according to claim 7, further comprising a stand being coupled to and extending away from said second clamp, said stand having a distal end with respect to said second clamp, said stand being oriented to extend upwardly from said handlebars.

10. The system according to claim 9, further comprising a base being coupled to and extending away from said stand, said base being positioned closer to said second clamp than said distal end of said stand, said base having a first surface, said first surface facing said distal end of said stand.

11. The system according to claim 9, further comprising a pair of grips, each of said grips being coupled to said stand, each of said grips being aligned with said distal end of said stand, each of said grips being positioned on opposite sides of said stand.

12. The system according to claim 11, wherein each of said grips comprises a leg and a foot, said leg corresponding to each of said grips extending laterally away from said stand, said foot corresponding to each of said grips extending perpendicularly away from said stand, said leg corresponding to each of said grips having a first section being slidably coupled to a second section such that said leg corresponding to each of said grip has a telescopically adjustable length, said foot corresponding to each of said grips having a first end.

13. The system according to claim 12, further comprising a pair of panels, each of said panels being coupled to said first end of an associated one of said grips, each of said panels having a primary surface, said primary surface of each of said panels facing each other, said electronic device being positioned on said first surface of said base, each of said panels being urged toward each other having said primary surface of each of said panels frictionally engaging said electronic device such that said electronic device is retained in said gripping unit.

14. The system according to claim 6, further comprising a second conductor being selectively electrically coupled between said plug on said first conductor and said electronic device such that said battery charges said electronic device.

15. A smart phone charging system comprising:
a bicycle having a frame, handlebars and a rear tire;
an electronic device;
a charging unit being coupled to said frame, said charging unit engaging said rear tire such that said rear tire rotates said charging unit wherein said charging unit is configured to produce an electrical current, said charging unit being electrically coupled to said electronic device such that said charging unit charges said electronic device, said charging unit comprising:
a first clamp being continuous such that said first clamp forms an open ring, said first clamp having a first side and a second side, said first clamp being positioned around said frame, said first clamp being positioned adjacent to said rear tire,
a pair of first fasteners, each of said first fasteners extending through said first side and engaging said second side wherein each of said first fasteners is configured to be manipulated, each of said first fasteners urging said first side toward said second side such that said first clamp is compressed around said frame thereby retaining said first clamp on said frame,
a generator being coupled to said first clamp,
a battery being positioned within said generator, said battery being electrically coupled to said generator such that said generator charges said battery,
a spindle being rotatably coupled to said generator, said spindle having an outer surface and a distal end with respect to said generator, said outer surface being concavely arcuate extending from said distal end towards said generator, said outer surface frictionally engaging an outer surface of said rear tire, said rear tire rotating said spindle when said bicycle is ridden such that said spindle rotates said generator, and
a first conductor being electrically coupled to said battery, said first conductor having a distal end with respect to said battery, said distal end of said first conductor having a plug being electrically coupled thereto;
a gripping unit being coupled to said handlebars, said gripping unit engaging said electronic device wherein said electronic device is configured to be accessible to a rider, said gripping unit comprising:
a second clamp being continuous such that said second clamp forms an open ring, said second clamp having a primary side and a secondary side, said second clamp being positioned around said handlebars,
a pair of second fasteners, each of said second fasteners extending through said primary side and engaging said secondary side wherein each of said second fasteners is configured to be manipulated, each of said second fasteners urging said primary side toward said secondary side such that said second clamp is compressed around said handlebars thereby retaining said second clamp on said handlebars,
a stand being coupled to and extending away from said second clamp, said stand having a distal end with respect to said second clamp, said stand being oriented to extend upwardly from said handlebars,
a base being coupled to and extending away from said stand, said base being positioned closer to said second clamp than said distal end of said stand, said base having a first surface, said first surface facing said distal end of said stand,
a pair of grips, each of said grips being coupled to said stand, each of said grips being aligned with said distal end of said stand, each of said grips being positioned on opposite sides of said stand, each of said grips comprising a leg and a foot, said leg corresponding to each of said grips extending laterally away from said stand, said foot corresponding to each of said grips extending perpendicularly away from said stand, said leg corresponding to each of said grips having a first section being slidably coupled to a second section such that said leg corresponding to each of said grip has a telescopically adjustable length, said foot corresponding to each of said grips having a first end, and
a pair of panels, each of said panels being coupled to said first end of an associated one of said grips, each of said panels having a primary surface, said primary surface of each of said panels facing each other, said electronic device being positioned on said first surface of said base, each of said panels being urged toward each other having said primary surface of each of said panels frictionally engaging said electronic device such that said electronic device is retained in said gripping unit; and
a second conductor being selectively electrically coupled between said plug on said first conductor and said electronic device such that said battery charges said electronic device.
